(19) United States
(12) Patent Application Publication
(10) Pub. No.: US 2003/0151269 A1
(43) Pub. Date: Aug. 14, 2003

(54) Cushioned gripping device for a hand tool

(76) Inventors: John S. Korellis, Livermore, CA (US); Wei-Yang Lu, Pleasanton, CA (US)

Correspondence Address: Timothy Evans, MS 9031, Sandia National Laboratories, 7011 East Avenue, Livermore, CA, 94550, US

(21) Appl. No.: 10/053,056

(22) Filed: Nov. 2, 2001

(51) Int. Cl. B25G 1/01

(52) U.S. Cl. 294/171; 81/489

(57) ABSTRACT

Rebound shock as well as hand and wrist fatigue associated with the use of a large wrench, is alleviated by a covering at least the butt end of the wrench with a sleeve, or gripping device, constructed from an pliant and deformable material, such as soft rubber. The gripping device may be provided for attachment to the elongated handle of a tool. It includes a sleeve dimensioned to encircle the tool handle along three sides and to extend along a substantial length of the handle. The gripping device may be mounted on the tool by means of an internal rib or ribs which lock the tool within the device channel cavity. In another embodiment, the device may include a series of finger size undulation along the outer surface to improve the ability of a person to maintain a grip. Because of its configuration and pliant material, the gripping device readily absorbs the impact forces due to torque applied during operation of the wrench that would otherwise be transmitted through the handle, and thereby provides ergonomic shock protection for the craftsperson's hand.

The United States Government has rights in this invention pursuant to Contract No. DE-AC04-94AL85000 between the United States Department of Energy and Sandia Corporation for the operation of Sandia National Laboratories.

### FIELD OF THE INVENTION

The present invention relates in general to a cushioned gripping device for use with hand tools of the type employed in the construction trades, particularly for tools used for manipulating fasteners and the like. The improved device comprises a sleeve constructed from an pliant, deformable material, that is placed over the handle of a wrench and lessens the force imparted to an operators hand when operating the a wrench by distributing the applied force to a wider area of the hand while slightly elastically deforming against the tool surfaces.

### BACKGROUND OF THE INVENTION

1. Field of the Invention

The present invention relates generally to a cushioned gripping device for selective attachment to the elongated handle of a tool, in particular, to the end of a wrench. The device of the present invention serves to cushion the user's and thus prevent or ameliorate injury to the palm, fingers, and wrist of the hand due to shock induced compression of these tissues as torsional forces are applied the end of a handled tool to operate the tool. The device of the present invention also provides protection against slippage and abrasion/laceration due to loss of a grip on the tool by providing a surface which the use can more easily hold.

2. Description of the Prior Art

The use of hand tools which operate by application of torsion to a fastener, such as wrenches and the like, for an extended period of time can cause impact and repetitive stress injury to the user. For example, nerve damage to the finger and palm can occur if these tissues are subjected to localized compression. Gloves offer only limited relief as they provide little cushion to the user's hand.

It is known to provide cushioned devices to protect a user's hands when engaged in various activities. For example, U.S. Pat. No. 5,023,128 discloses an impact absorbing pad which includes a plurality of parallel, elongated, individually sealed hollow pneumatic tubes with coextensive webbing. In this instance, the pad is a shaped cushion which could be used as a kneeler, pillow, or for a similar purpose.

U.S. Pat. No. 4,977,621 discloses a one-piece multi-purpose hand-cushioning device providing protection to the palm area of the hand from trauma associated with athletic and job-related activities. The pad is manufactured from die cut neoprene with a bonded nylon backing, with or without an additional bonded raised cushion in the palm area. Four finger holes are provided to eliminate the requirement for any type of fasteners.

U.S. Pat. No. 4,754,858 discloses a cushioning pad for relieving the strain of carrying luggage. The pad is removable and attachable to a plurality of luggage pieces by means of a pair of stretchable elastic bands provided in the cushioning pad by through holes positioned at each end thereof. The cushioning pad can be used on handheld luggage as well as luggage using an over-the-shoulder strap.

U.S. Pat. Nos. 5,195,230, 4,696,090, 4,567,639, and 4,241,496, and the patents cited therein, disclose a variety of impact tool configurations for cutting and seating telephone wires in terminal blocks mounted to telephone office mainframe units. The force imparted by the impact tool imparts a recoil shock to the users hand.

It was in light of the foregoing prior art that the present invention was conceived and has now been reduced to practice.

### SUMMARY OF THE INVENTION

In accordance with the present invention, this potentially harmful rebound shock problem is substantially alleviated by a new and improved tool handle configuration containing cushioning sleeve comprising an elastically deforming material, such as a pliable urethane. The sleeve is disposed so that it overlies at least a portion of the shank end of a structurally rigid tool handle such as a wrench.

According to the present invention, a cushioned gripping device is provided for selective attachment to the elongated handle of a tool. It includes an open, elongated sleeve of a pliable, deformable material dimensioned to substantially surround the handle of the tool on about three sides and at one end, and to extend along a substantial length of the handle. The sleeve contains a hollow recess along most of its length which is just wide enough that the sleeve can be slipped over the tool handle. In addition, the sleeve may contain several integrally molded ribs along the inside edges of the hollow recess to engage the tool handle as it is inserted, snapping over the outside edge of the handle and holding the tool within the sleeve recess.

In another embodiment, the device of the present invention may include a contoured outer surface to generally match a set of closed fingers thereby improving the ability of a person to maintain a grip. The device may be generally tubular, or it may be a generally elongated rectangular box. In either case the device is open along most of one side of its length, an has an inner dimension substantially similar in size to the outer dimension of the handle of the tool which it is intended to surround. Yet again, the device may be generally planar and rectangular, having a width dimension generally equal to the outer periphery of the handle.

It is, however, a primary object of this invention to provide a cushioned gripping device of customized size and placement for attachment to the elongated handle of a tool or other article having a handle to be gripped.

Another object of the invention is to provide such a cushioned gripping device which utilizes existing pliable elastomeric materials which can be ready molded or cast to shape.

A further object of the invention is to provide such a cushioned gripping device which may be reused indefinitely.

Still a further object of the invention is to provide such a cushioned gripping device which is generally of a flattened box-like construction which is able to slip over the end a tool handle and which can conform to the size and shape of the handle to which it is to be attached.

Other features, advantages, and benefits of the invention will become apparent in the following description taken in conjunction with the following drawings. It is to be understood that the foregoing general description and the following detailed description are exemplary and explanatory but are not to be restrictive of the invention. The accompanying drawings which are incorporated in and constitute a part of this invention, illustrate one of the embodiments of the invention, and, together with the description, serve to explain the principles of the invention in general terms. Like numerals refer to like parts throughout the disclosure.

### BRIEF DESCRIPTION OF THE DRAWINGS

FIG. 1A is a top view of a cushioned gripping device as disclosed by the present invention.

FIG. 1B is a side view of a longitudinal section of the cushioned device.

FIG. 1C is an end view of a transverse section of the cushioned device.

FIG. 1D is a top view of the cushioned gripping device as it might appear containing one end of a typical open end wrench.

FIG. 1E is a side view of the cushioned gripping device as it might appear containing one end of a typical open end wrench.

FIG. 2A is a second embodiment of the invention showing is a bottom view of the device with finger grooves molded into the cushioned device exterior wall.

FIG. 2B is a side view of the cushioned device embodying the finger grooves.

FIG. 3A is a top view of a cushioned gripping device having integral tabs molded into the interior wall of the device.

FIG. 3B is a side view of a longitudinal section of the cushioned device having the integrally molded tabs.

FIG. 4A is a bottom view of a cushioned gripping device containing an embedded magnet.

FIG. 4B is a side view of a longitudinal section of the cushioned device containing an embedded magnet.

### DETAILED DESCRIPTION

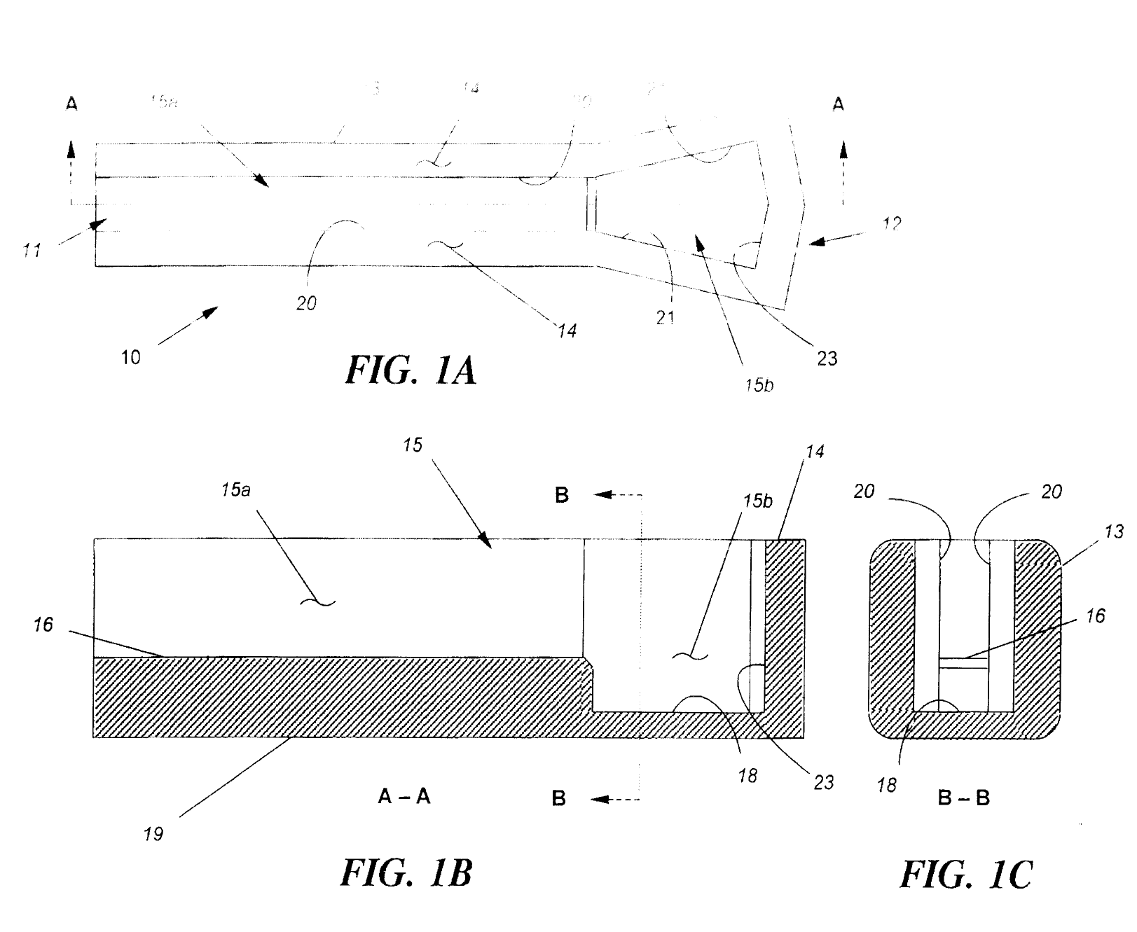

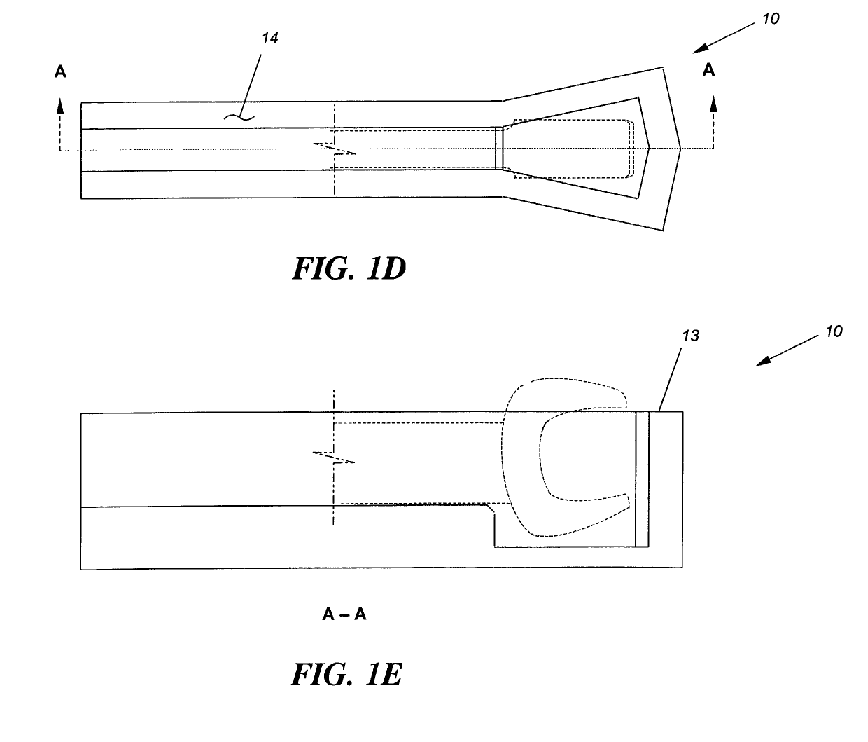

Attention is now directed to FIGS. 1A-1E, which diagrammatically illustrate one embodiment of a cushioned box-like sleeve configuration in accordance with the present invention. In particular, FIGS. 1D and 1E provide an illustration of how the cushioned device might appear when used with a typical open end wrench.

As shown in FIGS. 1A-1C, cushioned tool 10 comprises an elongated box-like housing or open sleeve 13 constructed from a deformable, semi-rigid material, such as, for example, a urethane polymer. The sleeve is designed such that it is open at one end and along its top surface 14. Sleeve or housing 13 has interior sides 20 floor surfaces 16 and 18, and end wall 23 defining a channel 15 that is sized to accommodate therein a tool handle such as that handle of a wrench.

Open end 11 of cushioned tool 10 is characterized by a narrow, interior channel portion 15 defined by side walls 20, that are generally parallel to longitudinal plane A-A, and floor 16, that is generally perpendicular to plane A-A. The channel or “slot” 15 is intended to accommodate a portion of the shank end or handle of a wrench, or similar tool, and to be long enough for a craftsperson to comfortably grasp and operate. The portion 15a of channel 15 therefore, is sized to accommodate about 6 to 8 inches of a tool handle. Furthermore, side walls 20 and floor 16 of sleeve or housing 13 are provided with sufficient width and thickness to distribute and thereby lessen any pressure on the hand of an operator across as wide and area as possible.

To accommodate various types of tools, closed end 12 of cushioned tool 10 is designed to include an expanded “head” to accommodate the size and shape of either end of a box wrench or combination box-open end wrench. These tools are themselves designed with functional ends whose features are rotated within or out of the plane of the tool handle. In particular, socket ends of such wrenches are typically oriented at an angle 10° to 12° out of the tool plane, while the fixed jaw of an open end wrench is typically rotated by about 15° in the plane of the tool with respect to the tool longitudinal axis. In order to account for this, sides 21 are flared outward away from sides 20 at an angle of about 10° to 12° , in order to match the angle of the socket end of the box wrench. Furthermore, channel portion 15 is deepened across the area of the closed end 12 such that floor 16 is lowered to a new floor level 18 so that cavity portion 15b at closed end 12 is wider and deeper than channel cavity portion 15a. The transition between floor 16 and 18 may be fashioned as a step or at an angle greater than about 45°.

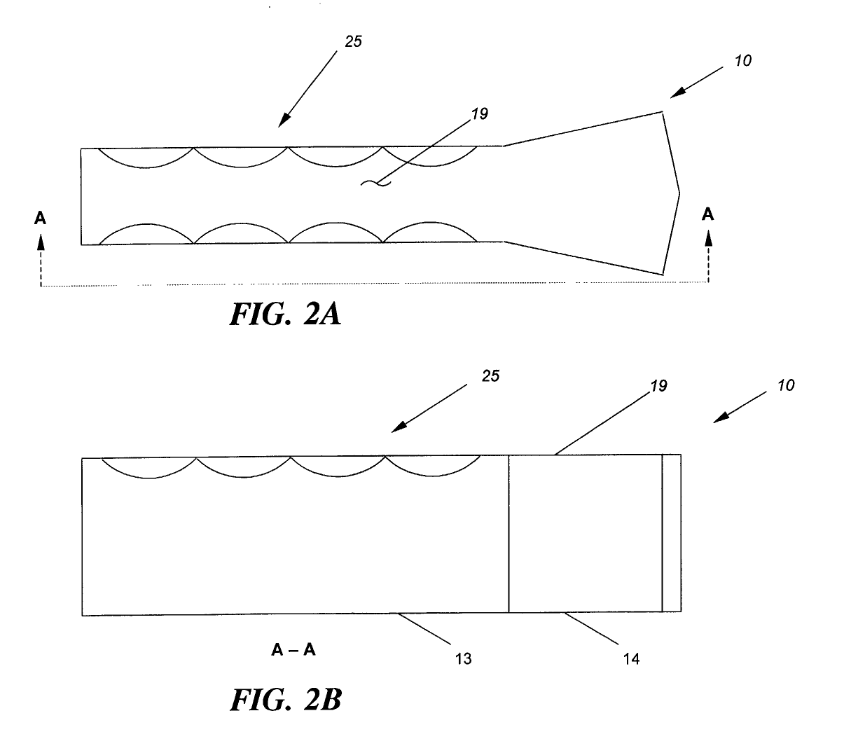

Further embodiments are shown in FIGS. 2, 3 and 4.

In FIGS. 2A and 2B the cushioning device is shown with a set of finger grooves 25 molded into the exterior wall of sleeve or housing 13 along the underside of the cushioning device in order to provide for a gripping surface that conforms to a craftsperson's hand. In the illustrated example the grooves are shown molded into the two edges running along surface 19. The illustration, however, show a design that has not been optimized for ergonomic operation and should not be construed as the sole configuration. Other configurations are, of course, possible in order to enhance the efficient use of the device described and disclosed by the present invention.

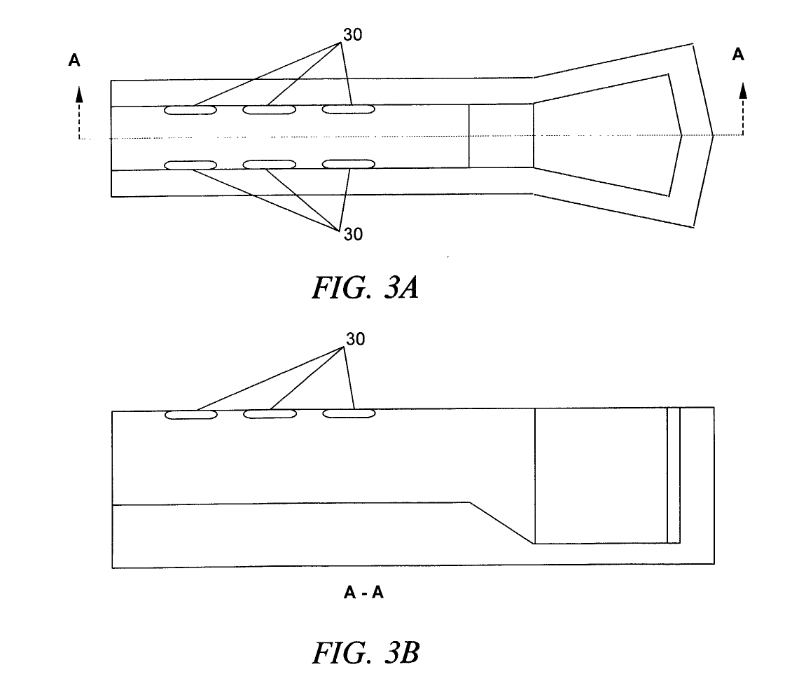

In FIGS. 3A-3C an embodiment is illustrated that allows for securing the cushioning device onto a tool. Several integrally molded tabs or “ribs” 30 are incorporated along the inside edges of the hollow recess in order to engage the tool handle as it is inserted, snapping over the outside edge of the handle and holding the tool within the sleeve recess. Six tabs are shown in the present embodiment but more or fewer are possible.

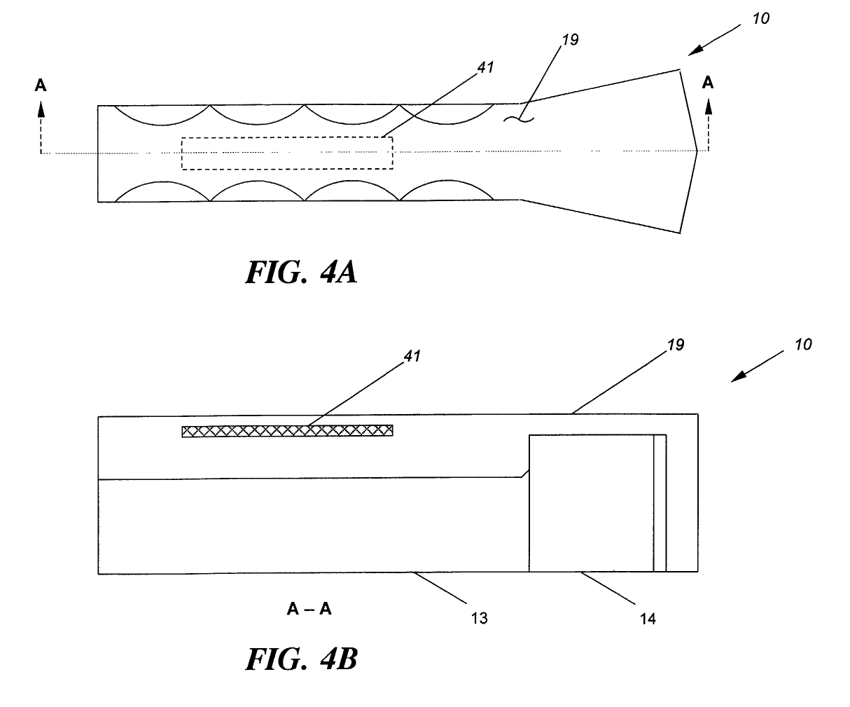

Finally, FIGS. 4A and 4B illustrate an embodiment comprising a magnet 41 embedded along one side or along the bottom of the cushioning device housing. The purpose of the magnet is to enable easy storage on the side of a tool box.

Lastly, any moldable or castable material that is semi-rigid and pliable, so that it is at least moderately deformable, is useful for fabricating the cushioned gripping device of this invention. Materials such as natural or synthetic polyisoprene rubbers, urethanes, polysiloxanes (e.g. Silicones), polychloroprene (e.g. Neoprene®), polymethane (e.g. Adiprene®), butadiene, acrylonitrile butadiene, fluorocarbon (particularly vinylidene fluoride/hexafluoropropylene copolymers, e.g. Viton®), ethylene propylene, polypropylene, and polyethylene all can be used to fabricate the device of the present invention.

As will be appreciated from the foregoing description of the invention, the above-referenced impact problem and resultant hand and wrist fatigue associated with the use of a craftsperson's tool, is substantially alleviated by providing the tool handle with a cushioning sleeve comprising a pliant and deformable material, such as rubber or polyurethane. Because of its configuration and pliant nature, the cushioning sleeve distributes and thereby lessens the compressive force imparted to the hand of a craftsperson as the craftsperson applies compression to the handle of a tool such as a wrench. The force of compression that would otherwise have been transmitted through the handle to the craftsperson's hand, is therefore substantially reduced because it is spread over a much wider area on the hand and thereby provides protection against the potential of repetitive stress injury.

While an embodiment has been shown and described in accordance with the present invention, it is to be understood that the same is not limited thereto but is susceptible to numerous changes and modifications as known to a person skilled in the art, and it should be understood, therefore, that this embodiment is not meant to unduly limit the invention to the details shown and described but is intend to cover all such changes and modifications as are obvious to one of ordinary skill in the art.

What is claimed:

1. A cushioned gripping device, comprising:
an open sleeve for engaging and partially surrounding an end portion of a tool handle, said open sleeve comprising a deformable material sized to accommodate and releasably hold said tool handle portion and to comfortably fit a tool operator's hand, said cushioned gripping device lessening thrust forces imparted to said tool operator's hand when operating said tool by distributing said thrust forces across a portion of said open sleeve.

2. The cushioned gripping device according to claim 1, wherein said open sleeve comprises a box-like housing having elongated side walls, an end wall, and a floor to provide an interior channel open along a top surface opposite said floor and at one end for surrounding said tool portion at three sides.

3. The cushioned gripping device according to claim 2, wherein a portion of said interior channel cavity is wider and deeper at an end opposite said open end in order to accommodate an enlarged tool element provided at an end of said tool.

4. The cushioned gripping device according to claim 3, further comprising:
a continuously contoured outer surface having a plurality of undulations which are longitudinally spaced along a length of said open sleeve, each said undulation extending at least along the underside of the handle of the tool, said undulations generally conforming to the fingers of a person's hand to improve the ability of said person to maintain a grip thereon.

5. The cushioned gripping device according to claim 2, further comprising at least one embedded magnet.

6. The cushioned gripping device according to claim 4, wherein said pliant deformable material comprises a material selected from the group consisting of natural or synthetic polyisoprene rubbers, urethanes, polyurethanes, polysiloxanes, polychloroprene, polymethane, butadiene, acrylonitrile butadiene, fluorocarbons, vinylidene fluoride/hexafluoropropylene copolymers, ethylene propylene, polypropylene, and polyethylene.

7. The cushioned gripping device according to claim 3, wherein said elongated side walls include one or more tabs molded into and spaced along a top edge of each of said side walls, said ribs for slideably engaging and thereby releasably securing said tool handle portion within said interior cavity.

8. The cushioned gripping device according to claim 7, further comprising:
a continuously contoured outer surface having a plurality of undulations which are longitudinally spaced along the length of said open sleeve, each said undulation extending at least along the underside of the handle of the tool, said undulations generally conforming to the fingers of a person's hand to improve the ability of said person to maintain a grip thereon.

9. The cushioned gripping device according to claim 7, further comprising at least one embedded magnet.

10. The cushioned gripping device according to claim 9, wherein said pliant deformable material comprises a material selected from the group consisting of natural or synthetic polyisoprene rubbers, urethanes, polyurethanes, polysiloxanes, polychloroprene, polymethanes, butadienes, acrylonitrile butadiene, fluorocarbons, vinylidene fluoride/hexafluoropropylene copolymers, ethylene propylene, polypropylene, and polyethylene.
